(19) United States
(12) Patent Application Publication
(10) Pub. No.: US 2006/0018655 A1
(43) Pub. Date: Jan. 26, 2006

(54) Photo processing apparatus

(75) Inventor: Toshiki Yoshida, Wakayama (JP)

Correspondence Address: NIXON PEABODY, LLP, 401 9TH STREET, NW, SUITE 900, WASHINGTON, DC, 20004-2128, US

(73) Assignee: Noritsu Koki Co., Ltd., Wakayama-shi (JP)

(21) Appl. No.: 11/178,398

(22) Filed: Jul. 12, 2005

(30) Foreign Application Priority Data
Jul. 22, 2004 (JP) 2004-214710

(51) Int. Cl. G03D 5/00

(52) U.S. Cl. 396/611

(57) ABSTRACT

The photo processing apparatus of the present invention, connected to a terminal via a network, includes: a data storage section for storing data; an order storage section for storing an order specifying data to be printed among data stored in the data storage section; a printing section for printing data specified in an order stored in the order storage section on printing paper; and a control section for receiving a printing instruction specifying data to be printed from the terminal via the network and controlling storing of the received printing instruction in the order storage section as an order.

### CROSS-REFERENCE TO RELATED APPLICATIONS

This application claims priority under 35 U.S.C. § 119 on Patent Application No. 2004-214710 filed in Japan on Jul. 22, 2004, the entire contents of which are hereby incorporated by reference.

### BACKGROUND OF THE INVENTION

The present invention relates to a photo processing apparatus connected to a terminal via a network.

A photo processing apparatus for printing images captured by cameras on printing paper performs calibration to attain good reproduction of the color/density of a captured image. The calibration is generally performed by outputting a reference chart having images for calibration (i.e., patches such as cyan (C), magenta (M), yellow (Y) and gray patches of various densities) recorded therein on printing paper, measuring the densities of the patches of the chart with a density measuring device, preparing a table for calibration from the target densities (of the image data given for recording in the chart) and the densities of the reference chart measured with the density measuring device, using an algorithm and the like, and incorporating the prepared table in an image data processing section of the photo processing apparatus. The photo processing apparatus corrects image data supplied from an image data supply source using this table to provide a photo print as a good reproduction of an image corresponding to the supplied image data.

Calibration data obtained in a photo processing apparatus is unique to the apparatus. Conventionally, therefore, the operator is required to operate the photo processing apparatus to instruct the apparatus to execute calibration. Moreover, the operator must stop ongoing print processing, if any, before issuing the instruction for executing calibration, or wait for termination of ongoing print processing and issue the instruction for executing calibration after the termination of the processing.

### SUMMARY OF THE INVENTION

An object of the present invention is providing a photo processing apparatus capable of improving the work efficiency.

The photo processing apparatus of the present invention is a photo processing apparatus connected to a terminal via a network, including: a data storage section for storing data; an order storage section for storing an order specifying data to be printed among data stored in the data storage section; a printing section for printing data specified in an order stored in the order storage section on printing paper; and a control section for receiving a printing instruction specifying data to be printed from the terminal via the network and controlling storing of the received printing instruction in the order storage section as an order.

Preferably, the data specified in the printing instruction is calibration data.

Preferably, the data specified in the printing instruction is management data of the photo processing apparatus. Examples of the management data include the number of prints processed per day, the sales, the trouble history and the like.

Preferably, the timing at which the data should be printed is specified in the printing instruction, and the printing section prints the data specified in an order corresponding to the printing instruction, among orders stored in the order storage section, at the timing specified in the printing instruction. Examples of the specified timing include “between a given order and another order”, “after the last order for the day”, and “as the last print in an order or the last print out of rolled printing paper (immediately before cutting).

The photo processing apparatus described above permits an external terminal connected thereto via a network to issue an instruction for printing data stored in the photo processing apparatus. Accordingly, the operator of the terminal is relieved of operating the photo processing apparatus on his or her own for printing data stored in the photo processing apparatus, and thus the work efficiency enhances. In addition, printing can be made although data to be printed is not stored in the terminal.

The terminal can transmit a printing instruction to the photo processing apparatus even when printing for a certain order is underway in the photo processing apparatus without the necessity of stopping the undergoing printing.

The timing at which data is to be printed can be specified in a printing instruction from the terminal. For example, printing of given data at the end of work for the day can be set in advance at the startup of the photo processing device. Also, the timing can be specified so that given data be printed as the last print in an order or the last print available from rolled printing paper. This can reduce loss of paper. In the conventional photo processing apparatuses in which image data and the like are printed on rolled printing paper, a piece of paper of a minimum length is necessary even when only one print or several prints are to be obtained (when only one or several data unit(s) are to be printed in one order), causing loss of paper. In the photo processing apparatus described above, in printing of data such as the management data and the calibration data as one print (or several prints), the printing timing can be specified so that the data be printed as the last print (or prints) in another order. This reduces loss of paper.

### BRIEF DESCRIPTION OF THE DRAWINGS

FIG. 1 is a block diagram of a system configuration of a photo processing apparatus of an embodiment of the present invention.

FIG. 2 is a view illustrating an example of data stored in a data storage section in FIG. 1.

FIGS. 3A to 3C are views showing examples of orders stored in an order storage section in FIG. 1.

FIGS. 4A and 4B are views showing examples of orders stored in the order storage section in FIG. 1.

### DESCRIPTION OF THE PREFERRED EMBODIMENTS

Hereinafter, a preferred embodiment of the present invention will be described with reference to the accompanying drawings.

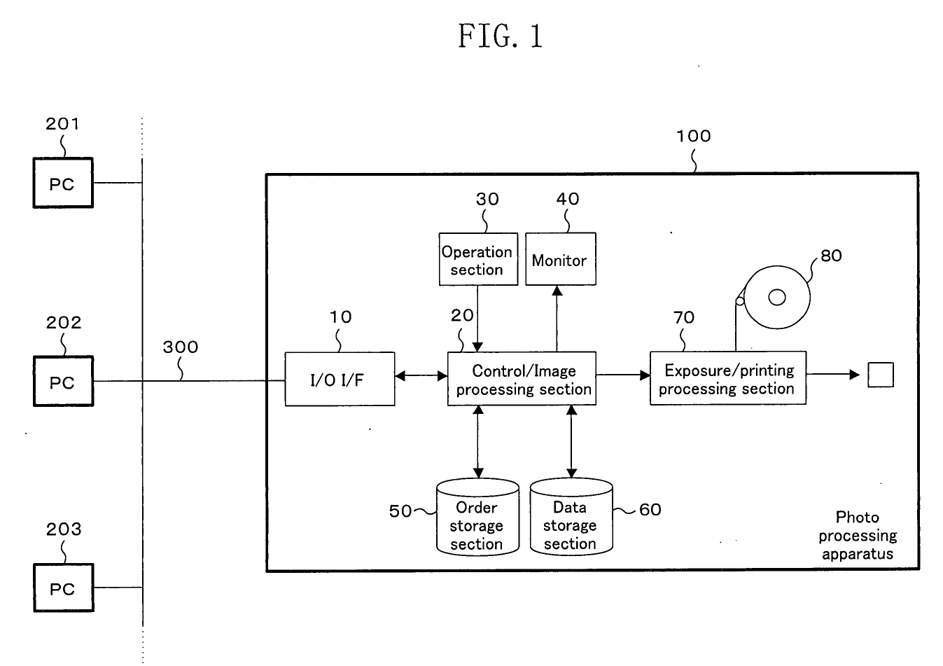

FIG. 1 is a functional block diagram of a photo processing apparatus of an embodiment of the present invention. The photo processing apparatus, denoted by 100, is connected with a plurality of terminals (personal computers (PCs)) 201 to 203 via a network 300. Each of the PCs 201 to 203 issues an instruction for printing data to the photo processing apparatus 100 via the network 300. In response to the printing instruction from any of the PCs 201 to 203, the photo processing apparatus 100 prints data stored therein.

The photo processing apparatus 100 includes an input/output (I/O) interface (I/F) 10, a control/image processing section 20, an operation section 30, a monitor 40, an order storage section 50, a data storage section 60 and an exposure/printing processing section 70.

The I/O I/F 10 transfers information received from the PCs 201 to 203 via the network 300 to the control/image processing section 20, and also sends information to be output externally, received from the control/image processing section 20, out on the network 300.

The control/image processing section 20 performs various types of processing for data handled by the photo processing apparatus 100. Examples of such processing include storing printing instructions transmitted from the PCs 201 to 203 via the network 300 in the order storage section 50 as orders, preparing and storing calibration data in the data storage section 60, storing management data of the photo processing apparatus 100 in the data storage section 60, and transferring data to be printed specified in orders stored in the order storage section 50 to the exposure/printing processing section 70.

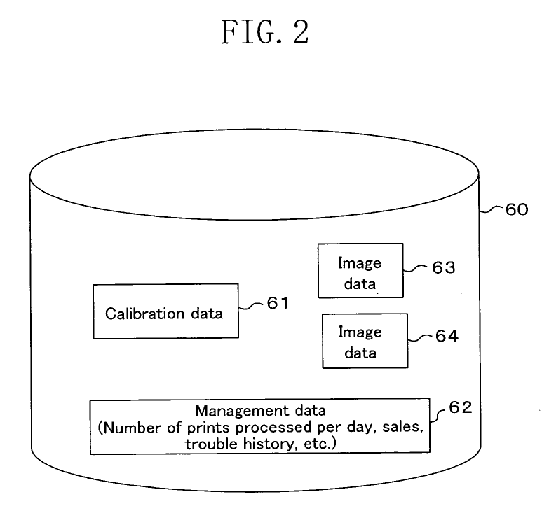

The data storage section 60 stores therein data to be printed by the photo processing apparatus 100. FIG. 2 illustrates an example of data stored in the data storage section 60. In the illustrated example, image data 63 and 64, calibration data 61 and management data 62 are stored in the data storage section 60. Each of the image data 63 and 64 includes a plurality of image data units to be printed in one order. The image data 63 and 64 may be data transferred to the data storage section 50 from a recording medium such as a memory card and a CD via a card slot, a CD drive and the like (not shown), or data that is first retrieved from a recording medium such as a memory card in a terminal (such as any of the PCs 201 to 203 and a print reception terminal (not shown)) connected to the photo processing apparatus 100, then transmitted from the terminal to the photo processing apparatus 100 via the network 300 and stored in the data storage section 50 via the I/O I/F 10. The calibration data 61 refers to parameters for preparing image data used for outputting a reference chart for calibration (calibration image data) or even the calibration image data itself. The management data 62 includes the number of prints processed per day, the sales, the trouble history and the like.

The order storage section 50 stores therein orders specifying data to be printed among the data stored in the data storage section 60.

The exposure/printing processing section 70 exposes data transferred from the control/image processing section 20 to light on rolled printing paper 80, develops and dries the exposed printing paper, cuts the paper to obtain finished prints, and sorts the prints.

The operation section 30 receives an instruction from the operator of the photo processing apparatus 100 and controls the control/image processing section 20 according to the received instruction. The monitor 40 displays image data received from the control/image processing section 20 on the screen.

Next, the processing performed by the photo processing apparatus 100 configured as described above will be described. The photo processing apparatus 100 has a feature of permitting any of the PCs 201 to 203 connected thereto via the network 300 to issue an instruction for printing data stored in the data storage section 60. Hereinafter, processing related to this feature will be described by way of specific example.

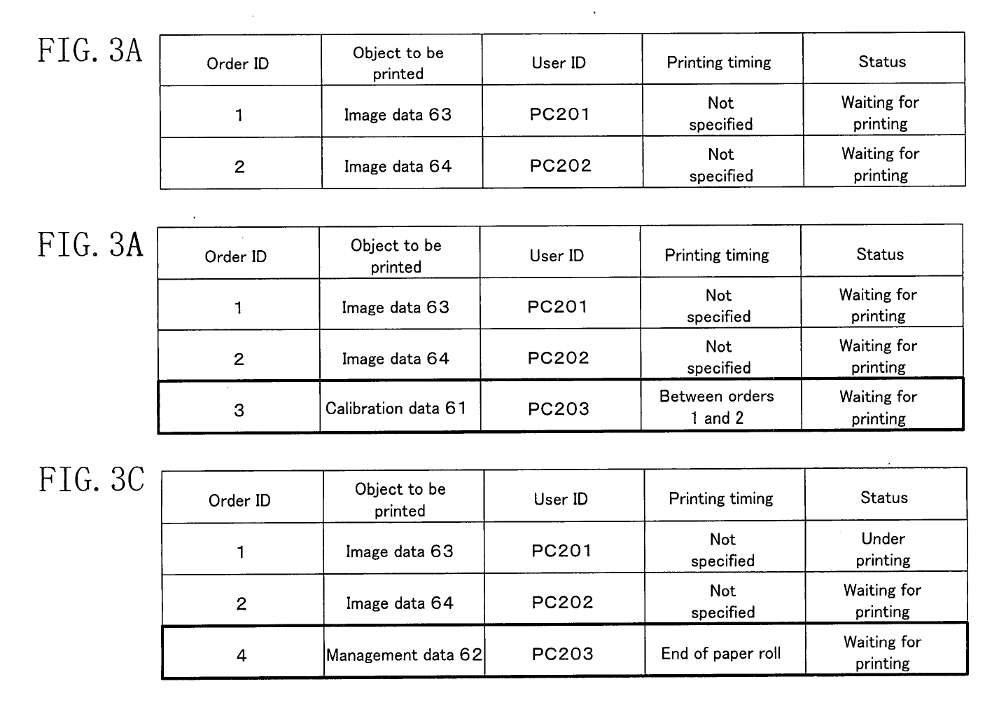

An instruction for printing the image data 63 is transmitted from the PC 201 to the photo processing apparatus 100. The printing instruction includes the user ID for identifying the transmission source (“PC 201” in this case), the object to be printed (“image data 63” in this case) and the printing timing (“not specified” in this case). Receiving the printing instruction from the PC 201, the control/image processing section 20 of the photo processing apparatus 100 identifies the printing instruction with a unique order ID (“1” in this case), and stores the instruction as one order with the order ID (“1”), the user ID (“PC 201”), the object to be printed (“Image data 63”) and the printing timing (“Not specified”) associated to each other in the order storage section 60 (see FIG. 3A).

Another instruction for printing the image data 64 is then transmitted from the PC 202 to the photo processing apparatus 100. This printing instruction includes the user ID for identifying the transmission source (“PC 202” in this case), the object to be printed (“Image data 64” in this case) and the printing timing (“Not specified” in this case). Receiving the printing instruction from the PC 202, the control/image processing section 20 of the photo processing apparatus 100 identifies the printing instruction with a unique order ID (“2” in this case), and stores the instruction as one order with the order ID (“2”), the user ID (“PC 202”), the object to be printed (“Image data 64”) and the printing timing (“Not specified”) associated to each other in the order storage section 60 (see FIG. 3A).

Information indicating the status of the printing processing (such as “Waiting for printing” and “Under printing”) is added to each order stored in the order storage section 60.

For orders having no specified printing timing, printing is made in the order of storing in the order storage section 50. In the case of FIG. 3A, therefore, the control/image processing section 20 of the photo processing apparatus 100 first transfers the image data 63 under the order ID “1” to the exposure/printing processing section 70 to allow the image data 63 to be printed in the exposure/printing processing section 70. The control/image processing section 20 then transfers the image data 64 under the order ID “2” to the exposure/printing processing section 70 to allow the image data 64 to be printed in the exposure/printing processing section 70.

As described above, the photo processing apparatus 100 permits the PCs 201 to 203 connected thereto via the network 300 to issue an instruction for printing data stored in the data storage section 60.

Data that can be specified for printing by the PCs 201 to 203 are not limited to the image data 63 and 64, but the calibration data 61 and the management data 62 can also be specified. In addition, the timing for printing can be specified in the printing instruction. For an order having specified printing timing, printing is made at the specified timing.

For example, assume that the PC 203 issues an instruction for printing the calibration data 61 to the photo processing apparatus 100 as shown in FIG. 3B. This printing instruction includes the user ID for identifying the transmission source (“PC 203” in this case), the object to be printed (“Calibration data 61” in this case) and the printing timing (“Between orders 1 and 2” in this case). Receiving this printing instruction from the PC 203, the control/image processing section 20 of the photo processing apparatus 100 identifies the printing instruction with a unique order ID (“3” in this case), and stores the instruction as one order with the order ID (“3”), the user ID (“PC 203”), the object to be printed (“Calibration data 61”) and the printing timing (“Between orders 1 and 2”) associated to each other in the order storage section 60.

The control/image processing section 20 of the photo processing apparatus 100 prepares the calibration data 61 as the object to be printed in the printing instruction as required and stores the prepared calibration data 61 in the data storage section 60. Once the printing of the image data 63 under the order ID “1” is terminated, the control/image processing section 20 transfers the calibration data 61 under the order ID “3” to the exposure/printing processing section 70 to allow the calibration data 61 to be printed in the exposure/printing processing section 70.

The photo processing apparatus 100 further permits the PCs 201 to 203 to issue an instruction for printing data stored in the data storage section 60 even when printing for a certain order is underway.

For example, assume that the PC 203 transmits an instruction for printing the management data 62 to the photo processing apparatus 100 when printing of the image data 63 under the order ID “1” is underway, as shown in FIG. 3C. This printing instruction includes the user ID for identifying the transmission source (“PC 203” in this case), the object to be printed (“Management data 62” in this case) and the printing timing (“End of paper roll (the last print available from the rolled printing paper 80)” in this case). Receiving the printing instruction from the PC 203, the control/image processing section 20 of the photo processing apparatus 100 identifies the printing instruction with a unique order ID (“4” in this case), and stores the instruction as one order with the order ID (“4”), the user ID (“PC 203”), the object to be printed (“Management data 62”) and the printing timing (“End of paper roll”) associated to each other in the order storage section 60.

In the photo processing apparatus 100, the remainder of the rolled printing paper 80 is detected with a sensor and the like. Once the situation comes where the management data 62 can be printed as the last print available from the rolled printing paper 80, the control/image processing section 20 transfers the management data 62 under the order ID “4” to the exposure/printing processing section 70 to allow the management data 62 to be printed in the exposure/printing processing section 70.

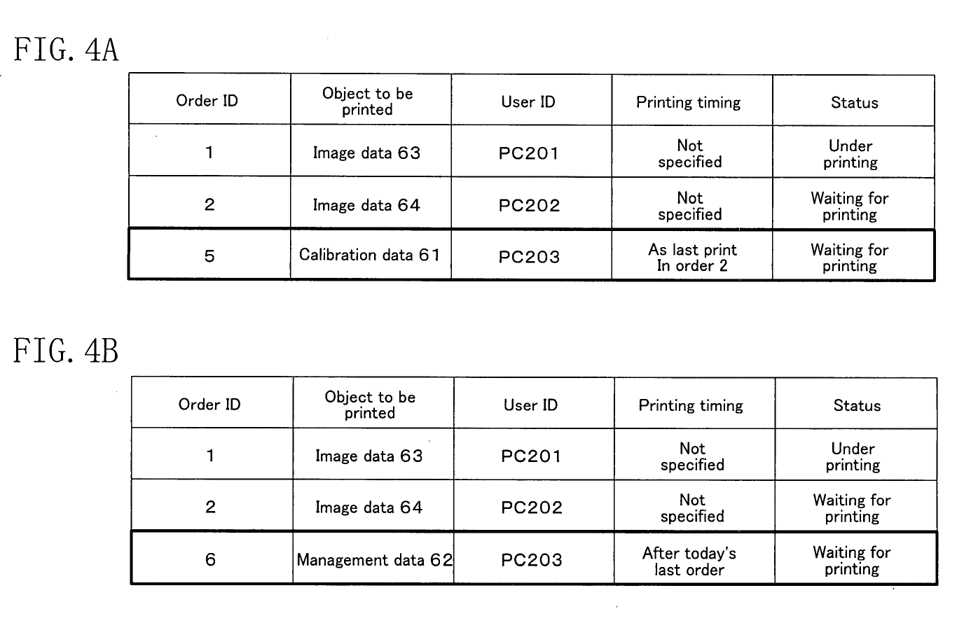

As the printing timing, other various situations can be set from the PCs 201 to 203, including “as the last print in a given order” as shown in FIG. 4A and “after the last order for the day” as shown in FIG. 4B.

As described above, the photo processing apparatus 100 of the embodiment of the present invention permits the PCs 201 to 203 connected thereto via the network 300 to issue an instruction for printing data stored in the photo processing apparatus 100. Accordingly, the operators of the PCs 201 to 203 are relieved of operating the photo processing apparatus 100 on their own for printing data stored in the photo processing apparatus 100, and thus the work efficiency enhances. In addition, printing can be made although data to be printed is not stored in the PCs 201 to 203.

The PCs 201 to 203 can transmit a printing instruction to the photo processing apparatus 100 even when printing for a certain order is underway in the photo processing apparatus 100 without the necessity of stopping the undergoing printing.

The timing at which data is to be printed can be specified in a printing instruction from the PCs 201 to 203. For example, printing of given data at the end of work for the day can be set in advance at the startup of the photo processing device 100. Also, the timing can be specified so that given data be printed as the last print in an order or the last print available from the rolled printing paper 80. This can reduce loss of paper. In the conventional photo processing apparatuses in which image data and the like are printed on rolled printing paper, a piece of paper of a minimum length is necessary even when only one print or several prints are to be obtained (when only one or several data unit(s) are to be printed in one order), causing loss of paper. In the photo processing apparatus 100 of this embodiment, in printing of data such as the management data and the calibration data as one print (or several prints), the printing timing can be specified so that the data be printed as the last print (or prints) in another order. This reduces loss of paper.

In the above embodiment, the photo processing apparatus was described as printing image data and the like on rolled printing paper (rolled printing paper 80). The present invention is also applicable to a photo processing apparatus that prints image data and the like on sheets of printing paper.

The present invention is applicable to photo processing apparatuses connected to terminals via a network. By adopting the present invention, the effects such as enhancing the work efficiency and reducing loss of paper can be obtained.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A photo processing apparatus connected to a terminal via a network, comprising:
a data storage section for storing data;
an order storage section for storing an order specifying data to be printed among data stored in the data storage section;
a printing section for printing data specified in an order stored in the order storage section on printing paper; and
a control section for receiving a printing instruction specifying data to be printed from the terminal via the network and controlling storing of the received printing instruction in the order storage section as an order.

2. The apparatus of claim 1, wherein the data specified in the printing instruction is calibration data.

3. The apparatus of claim 1, wherein the data specified in the printing instruction is management data of the photo processing apparatus.

4. The apparatus of claim 1, wherein the timing at which the data is to be printed is specified in the printing instruction, and the printing section prints the data specified in an order corresponding to the printing instruction, among orders stored in the order storage section, at the timing specified in the printing instruction.

5. The apparatus of claim 2, wherein the timing at which the data is to be printed is specified in the printing instruction, and the printing section prints the data specified in an order corresponding to the printing instruction, among orders stored in the order storage section, at the timing specified in the printing instruction.

6. The apparatus of claim 3, wherein the timing at which the data is to be printed is specified in the printing instruction, and the printing section prints the data specified in an order corresponding to the printing instruction, among orders stored in the order storage section, at the timing specified in the printing instruction.
